(19) United States
(12) Patent Application Publication
(10) Pub. No.: US 2009/0292654 A1
(43) Pub. Date: Nov. 26, 2009

(54) SYSTEMS AND METHODS FOR CALCULATING USE CHARGES IN A VIRTUALIZED INFRASTRUCTURE

(75) Inventors: Abhinav KATIYAR, Bangalore (IN); Jagannath RAGHU, Bangalore (IN); Hemanth PANNEM, Bangalore (IN); Mangesh PANGARKAR, Bangalore (IN)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/126,705

(22) Filed: May 23, 2008

(51) Int. Cl. G06Q 40/00

(52) U.S. Cl. 705/412

(57) ABSTRACT

A method for calculating computing resource use charges for a data center consumer entity is disclosed. The data center consumer entity accesses one or more of a plurality of computing resources in a data center. The method includes retrieving usage data of each of the plurality of computing resources. The usage data is retrieved for a selected period of use of each of the plurality of computing resources by the data center consumer entity. Each of the plurality of computing resources includes at least one of a CPU, a disk, a Network Interface Card (NIC), and a memory. The method further includes retrieving a rate plan data for the data center consumer entity and retrieving per unit charge, base rate, and rate factor for each of the plurality of computing resources. Further, a sum of a sum of multiplications of billed units of each of the plurality of computing resources by per unit charge, base rate, and rate factor is calculated. The billed units include one of actual used units or reserved units. The rate plan data includes information whether the actual used units or the reserved units to be used in calculating the sum.

### BACKGROUND

Computer software systems and applications are licensed to customers or users using per CPU licensing or per user licensing. For example, a vendor of a computer operating system may provide licenses based on the number of computers on which the computer operating system would be installed. In a virtualized infrastructure, licenses are generally provided using per “virtual machine” licensing.

### SUMMARY

In one embodiment, a method for calculating computing resource use charges for a data center consumer entity is disclosed. The data center consumer entity accesses one or more of a plurality of computing resources in a data center. The method includes retrieving usage data of each of the plurality of computing resources. The usage data is retrieved for a selected period of use of each of the plurality of computing resources by the data center consumer entity. Each of the plurality of computing resources includes at least one of a CPU, a disk, a Network Interface Card (NIC), and a memory. The method further includes retrieving a rate plan data for the data center consumer entity and retrieving per unit charge, base rate, and rate factor for each of the plurality of computing resources. Further, a sum of a sum of multiplications of billed units of each of the plurality of computing resources by per unit charge, base rate, and rate factor is calculated. The billed units include one of actual used units or reserved units. The rate plan data includes information whether the actual used units or the reserved units to be used in calculating the sum.

In another embodiment, an apparatus for calculating computing resource use charges for a data center consumer entity is disclosed. The data center consumer entity accesses a plurality of computing resources in a data center. The apparatus comprising a usage data collector module to collect usage data of each of the data center computing resources and a cost calculation module in communication with the usage data collector for calculating the computing resource usage charges based on usage and a rate plan. A chargeback database is included to store the rate plan, and a reporting module is included to generate a use charges report for a selected usage period and a selected one of the plurality of data center consumer entities based on cost calculations by the cost calculation module.

### BRIEF DESCRIPTION OF THE DRAWINGS

FIG. 1A illustrates an exemplary system for calculating an access cost of data center resources in accordance with one or more embodiments of the present invention.

FIG. 1B illustrates an exemplary host that is implemented in accordance with one or more embodiments of the present invention.

FIG. 2 illustrates an exemplary mapping of data center resources to business units of an organization in accordance with one or more embodiments of the present invention.

FIG. 3 illustrates a flow chart of a method for calculating access cost in accordance with one or more embodiments of the present invention.

### DETAILED DESCRIPTION

Systems and methods for billing in a virtualized infrastructure are disclosed. In particular, flexible billing or chargeback as applied to a virtual infrastructure provides a method for use by which organizations or hosted service providers to account for information technology (IT) operational costs pertaining to providing virtual infrastructure equipment, services, and applications.

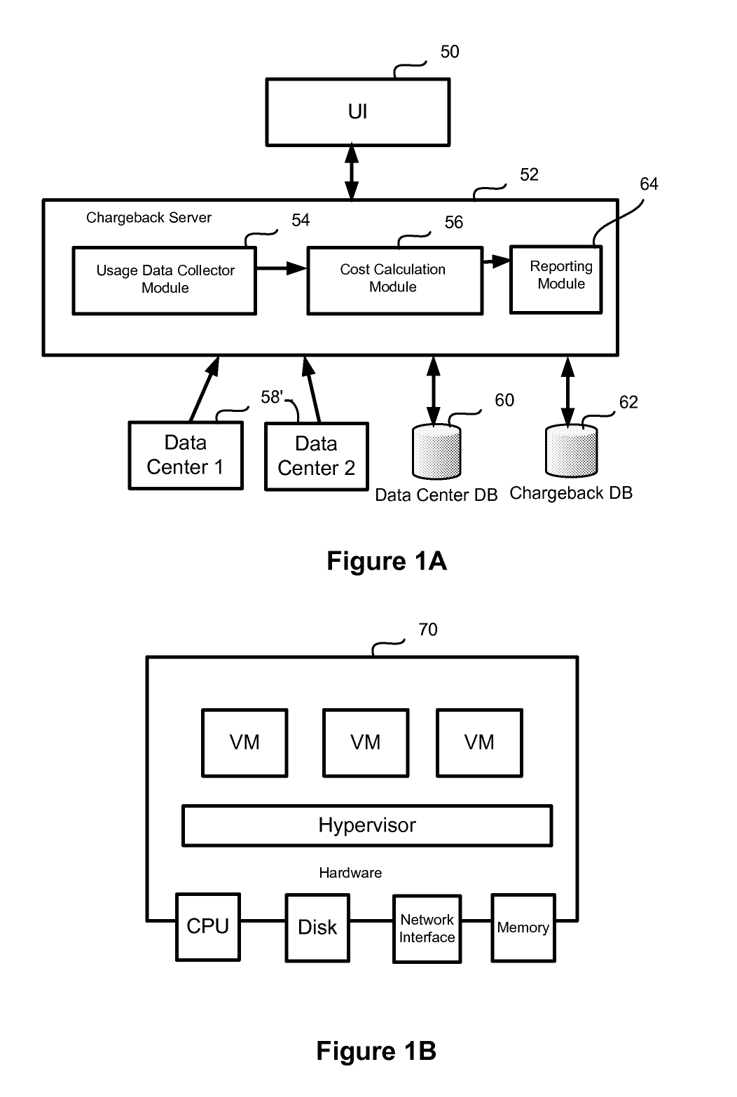

FIG. 1A illustrates an exemplary system for calculating an access cost of data center resources based on usage and rate plans. As shown in FIG. 1A, the system includes User Interface (UI) 50 to enable input of data relating, among other things, to configuration of rate plans (“rate plan data”), an organizational hierarchy, and a mapping of the organizational hierarchy to hosts and/or virtual machines in a data center. In one embodiment, UI 50 is in communication with Chargeback Server 52 through an HTTP protocol. In other embodiments, UI 50 can communicate with Chargeback Server 52 through other protocols such as SOCKS or HTTPS. Chargeback Server 52, in one embodiment, is an Internet server which provides a runtime environment for software modules. In one example, Chargeback Server 52 can be a J2EE™ Web server.

As further shown in FIG. 1A, Chargeback Server 52 includes Usage Data Collector Module 54 and Cost Calculation Module 56. In addition, Chargeback Server 52 is in communication with one or more data centers 58′. A data center includes physical servers (i.e., hosts) and virtual machines running in the physical servers. Each host includes one or more of a memory, a CPU, a Network Interface Card (NIC), and a storage device. Further, each virtual machine provides a virtual version of these computing resources. For example, a virtual machine includes a virtual CPU, a virtual NIC, etc. In one embodiment, each of a memory, a CPU, a Network Interface Card (NIC), a storage device and their virtual counterparts is defined to be a data center computing resource. In further addition, Chargeback Server 52 is also in communication with Data Center Database (DCDB) 60 to store the data center resources hierarchy, and a Chargeback Database (CBDB) 62 to store the organizational hierarchy. In accordance with this embodiment, CBDB 62 also stores the rate plan data. In one example, the rate plan data includes information to enable calculating an access cost of a particular resource in a data center by a particular department in the organizational hierarchy. Term “data center consumer entity”, as used herein, generally refers to a department in the organization hierarchy. In one or more embodiments, a consuming entity is a user of one or more of the hosts and/or the virtual machines in the data center.

Usage Data Collector Module 54, in one embodiment, continuously monitors usage data of data center computing resources of each host and virtual machine in the data center. The monitoring includes collecting data such as, for example and without limitation, CPU use, memory use, disk use, network use, etc. The usage data, in one embodiment, is stored in data center database 60. DCDB 60, in one embodiment, is a relational database, and in other embodiments, DCDB 60 can be any type of data storage medium so long as the stored data can be selectively retrieved.

In another embodiment, usage data monitoring is performed by an external system (for example, VMware Virtual Center™, VMware ESX Server™, etc.). Usage Data Collector Module 54, in this embodiment, retrieves the usage data of the data center resources from the external system. In one example, Usage Data Collector Module 54 performs aggregation using available usage data at VM, host, or any child entity level to calculate costs at any level in the organization hierarchy. The usage data, in one example, includes usage of one or more of the CPU, memory, network bandwidth, and disk(s). It may be noted that an application programming interface (API) to monitor usages and to retrieve usage data is commonly available. For example, VMware Virtual Center Server/ESX Server™ includes this API.

In accordance with one or more embodiments of the preset invention, cost calculation module 56 uses the monitoring data collected through Usage Data Collector Module 54 to calculate the cost of access for a given entity (i.e., a data center consumer). In one embodiment, Cost Calculation Module 56 executes in Chargeback Server 52, and uses monitoring data stored in DCDB 60 and cost plan data stored CBDB 62. In one embodiment, CBDB 62 is a relational database, and in other embodiments, CBDB can be a data store of any type so long as the information can be stored and retrieved selectively. In another embodiment, Cost Calculation Module 56 can also be implemented in CBDB 62 using database programming features such as triggers and stored procedures. In yet another embodiment, the Cost Calculation Module 56 can be implemented using a combination of database programming features and a high level programming features provided by Chargeback Server 52.

In one exemplary embodiment, CBDB 62 includes a cost model and a chargeback (CB) hierarchy. The cost model includes; (a) a listing of computing resources such as the CPU, the memory, the Disk, the NIC, etc.; (b) one or more billing or chargeback plans based on resource allocation and usage; (c) cost types such as fixed cost, usage based cost, and operational overheads of each of the hosts; and (d) the base rate and rate factor of each computing resource. The CB hierarchy, in one embodiment, includes a listing of departments, cost centers, or business units and sub-business units. In one embodiment, the cost model and the CB hierarchy can be entered and/or amended using UI 50. It may be noted that a virtual machine can be moved from one host to another. For example, if VM1 is moved from Host 1 to Host 2, one or more of the base rate, rate factor, and per unit charges can be updated in the cost model based on the hardware specification including the computing power of Host 2.

In accordance with one or more embodiments of the present invention, Reporting Module 64 provides reporting functionality which may include generating bills, usage data, etc. The system, in one embodiment, can be configured to generate bills and/or usage reports periodically. In one embodiment, the bills are generated in a format that is suitable for inputting the data into a corporate accounting or billing system for streamlined billing and reporting.

FIG. 1B illustrates host 70 that includes basic system components such as a CPU, memory, a disk, and a network interface. Host 70 incorporates a hypervisor such as VMware ESX Server™. One or more virtual machines executes in the hypervisor. Host 70, in one embodiment, is a basic building block of a data center. Host 70 includes computing resources such as one or more of a CPU, a disk, a network interface card, a storage device, and a memory. In one embodiment, the usage of these computing resources is monitored by Usage Data Collector Module 54 and charges are calculated based on these usage.

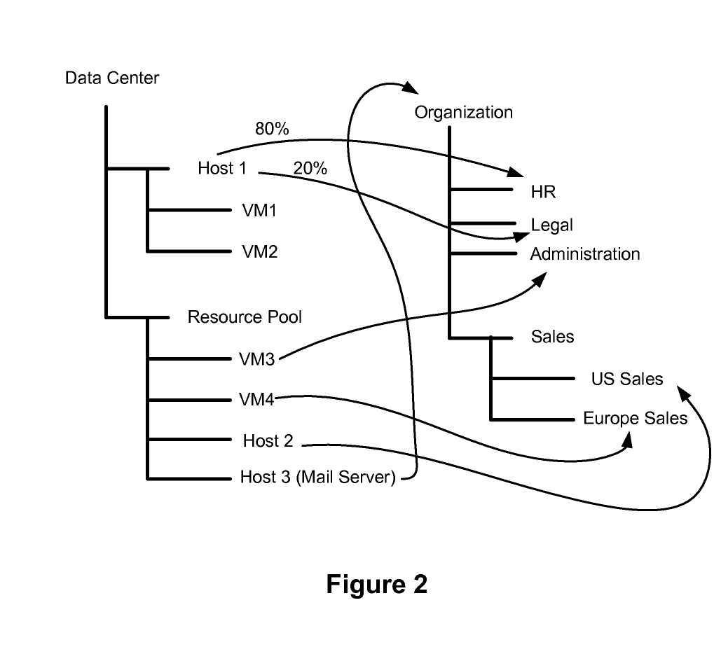

FIG. 2 illustrates an exemplary organization hierarchy as well as an exemplary data center resource hierarchy. In one embodiment, UI 50 can be used to configure these hierarchies. In one embodiment, a default data center resource hierarchy corresponding to a data center host setup is provided, and can be amended or adjusted according to changes in the availability of the hosts or virtual machines in the data center. In one embodiment, a mapping between the hosts/virtual machines and the organization is stored in CBDB 62. In other embodiments, this mapping can be stored in any database or data store so long as the mapping data is accessible to Cost Calculation Module 56 of CB Server 52.

As exemplary illustrated in FIG. 2, “Host 1” is mapped to the “HR” department and VM3 is mapped to the Administration department. In other words, the computing resources of Host 1 are reserved for use by the HR department and the computing resources of VM3 are reserved for sole use by the Administration department. In one example, the organization hierarchy can be replaced by a flat list of companies which are being served by a hosting company that sells a use of computing resources to these companies. Further, a host or a virtual machine may be mapped to more than one department or a member of the organization hierarchy. For example, an email server hosted on Host 3 is used by all departments, hence the cost can be apportioned either uniformly among all departments or based on a number of users of the mail server in each department. In other embodiments, the cost apportionment can be customized according to one or more sets of rules. In one embodiment, only a subset of the data center hierarchy is mapped to the nodes of the organization hierarchy. In one embodiment, the members of the organization hierarchy are termed as data center consumer entities. In one embodiment, the organization hierarchy and one or more rate plans for each of the members of the organization hierarchy are entered by administrator using UI 50. Base rates, rate factors, fix rates, etc. of each of the data center computing resources (i.e., CPUs, Disks, NICs, Memory, etc.) are also entered by administrator using UI 50.

In one embodiment, a virtual machine that is running in a particular host can be moved to another host. This another host may have a different hardware setup, hence, the unit charges or the rate factors of the computing resources in the another host may be different. In this case, the use charges for a data center consuming entity that is using the virtual machine may be updated based on the new unit charges or the rate factors. In one embodiment, Usage Data Collector Module 54 monitors any such movement of the virtual machines within the data center to update the use charges accordingly. Further, in one embodiment, Usage Data Collector Module 54 also monitors changes in the data center and organization hierarchies, as well as any change in the mappings between the data center and the organization. Cost Calculation Module 56 adapts to any such change and updates the usage charges accordingly.

In one embodiment, the cost of access includes one or more or a combination of one or more of the following cost types.

Fixed Cost: a data center consuming entity may be charged a fixed cost of the resource being consumed. Every computing resource is assigned a fix cost of operation. In one example, the fixed cost may include the cost of hardware, electricity, real estate, software licenses, maintenance, etc. In the example illustrated in FIG. 2, the fixed cost of Host 1 will include a sum of fix costs of VM1 and VM2. For example, if Host 1 is being used solely by the HR department, the HR department can be charged a fixed cost of operating Host 1.

Virtual Machine Computing Resource Cost: in an example, if a host computer is running multiple VMs, the cost of access can be apportioned among consuming entities by their actual use of the computing resources. For example, CPU use can be billed by GHz-Hour, Memory by GB-Hour, Network Bandwidth by GB (GB=Giga Bytes), Disk by GB-Hour, and Disk I/O by GB, etc. In another example, a particular consuming entity may be charged by the number of reserved units of these computing resources, irrespective of actual use. In yet another example, the consuming entity may be charged by the number of units used of each of these computing resources. It may be noted that several such billing combinations are possible and can be put in place as needed by entering a customized rate plan for a specific consuming entity using UI 50.

Virtualization Support Computing Resource Cost: in a virtualized infrastructure, a virtualization server that hosts a plurality of VMs also consumes a part of computing resources of a host. This cost is calculated at a Host level in the hierarchy, and in one embodiment, can be apportioned to all consuming entities that use the host. The apportionment can be uniformly among all consuming entities, or alternatively, the cost can be distributed based on the used computing resource units by each of the consuming entities. The rules pertaining to these apportionments can be entered by administrator using UI 50.

Unused Computing Resource Cost: in one embodiment, this cost can be calculated by subtracting units used by a consuming entity or entities from the maximum available computing resource units. This cost can be ignored, apportioned uniformly among all consuming entities, or apportioned according to the actual use of computing units by each of the consuming entities. The rules pertaining to these apportionments can be entered by administrator using UI 50.

In one embodiment, an apportionment of the cost of providing computing resources to consuming entities may be calculated by various methods such as by using models based on a fixed cost, reservation of the computing resources, actual use of the computing resources, maximum of actual use or reservation of the computing resources, and a combination thereof.

For example, if the cost of access is being calculated by the number of computing resources units used, a base rate of each unit (for example, CPU GHz-Hr base cost=$1.50) is assigned to each type of computing resource units (such as, CPU, Disk, etc.). In addition, in one embodiment, a rate factor may also be assigned to each of these unit types at any level in the organization hierarchy. In this example, the cost can be adjusted by adjusting the rate factor without any need for adjusting the base rates. In another example, the rate factor can be time dependent. For example, the rate factor for some computing resources at any level in an organization hierarchy is high when additional services such as High Availability or Fault Tolerance are provided. In one exemplary scenario, the rate factor for a CPU may be higher for a system having a Xeon processor than for one having a Celeron processor. In one embodiment, if a rate factor is applied at a particular node (i.e., a data center computing resource) in the VC hierarchy, the rate factor also applies to all children of the node. In another embodiment, this rate factor can be overridden at any child node level by applying another rate factor for the child node.

In one embodiment, if utilization data is not available for a period of time, the cost of access of a particular computing resource can be apportioned by extrapolating actual usage of the computing resource from a period when the utilization data was available. In another embodiment, the cost during this period when utilization data is unavailable may be waived. In yet another embodiment, the administrator may enter rules using UI 50 to calculate this cost. In one example, one of the rules may include a varying cost depending upon particular days of a month (e.g., half charges for the use on Sundays, a fix dollar amount for the use on Mondays, etc.).

In one embodiment, in a fixed cost model, the cost of access of a VM is the fixed cost at that VM level in the VC hierarchy. In one example, the fixed cost of operating a host can be calculated by adding hardware cost, energy cost, personnel cost, cost of real estate, cost of software licenses, etc. This fixed cost, in one example, can then be apportioned among all the virtual machines that are running on that host.

In the Virtual Machine Computing Resource cost model, the cost of each type of computing unit=Chargeable Virtual Machine Computing Resource Units×Rate Factor×Base Rate. The unused computing resource cost=host unused computing resource units attributed to the VM×Rate Factor×Base Rate. Hence, in an example in which a rate plan includes a combination of various types of access costs, the total cost of access=total fixed cost+total virtual machine computing resource cost+total virtualization support computing resource cost+total unused computing resource cost.

In one example, a consuming entity may choose to be billed by a particular type of rate plan. The rate plan may be customized by combining fix rate plan and plans based on actual or reserved computing units. In one embodiment, the customized rate plan includes time dependent rate factors or access cost. For example, the cost of access of a particular computing resource may vary depending on overall demand and load on the system. In one embodiment, the rate factor for a particular computing resource is configured by administrator using UI 50 to vary with the demand and load on the system measured in terms of CPU and/or disk usage at a particular time or during a particular time interval. In another embodiment, the consuming entity may be charged based on a max usage of one or more of the computing resources. For example, if the consuming entity generally uses five units of a computing resource but used ten units during a peak use, the charges will be based on ten unit of usage. In yet another embodiment, the charges may be based on a customized formula including provisions to charge or not to charge the consuming entity for the usage of the computing resources during a particular period or weeks or months, etc. For example, a formula may include provision not to charge the usage of the computing resources in the first week of January or during days set for maintenance.

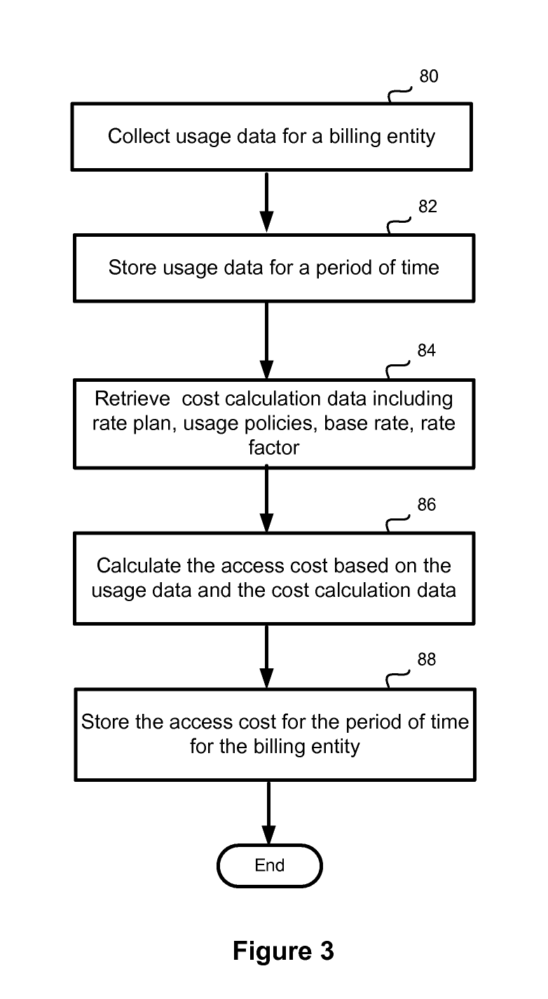

FIG. 3 illustrates a flow diagram of a method of calculating the access cost of a computing resource by a consuming entity during a period of time. At operation 80 shown in FIG. 3, usage data of the computing resource for the period of time for the consuming/billing entity is collected. In one embodiment, Usage Data Collector Module 54 shown in FIG. 1A provides the usage data. Next, at operation 82 shown in FIG. 3, the usage data for the period of time is stored in a database. Next, at operation 84 shown in FIG. 3, the cost calculation data is retrieved from a database. In one embodiment, CBDB 62 shown in FIG. 1A provides this cost calculation data. The cost calculation data includes: (a) the rate plan for the consuming entity; and (b) the base rates and rate factors of various computing resources. Next, at operation 86 shown in FIG. 3, the access cost is calculated using the usage data, rate plan, base rate, rate factor, and so forth time as set forth herein. Next, at operation 88 shown in FIG. 3, the cost of access for the period of time for the consuming entity is stored in a database. This cost data is then used for generating reports or use charges for a particular member of the organization hierarchy.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the billing in the virtualized infrastructure and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A method for calculating computing resource use charges for a data center consumer entity, the data center consumer entity accessing one or more of a plurality of computing resources in a data center hierarchy, the data center consumer entity being a member of an organization hierarchy, the method comprising:
creating mappings between one or more members of the organization hierarchy and one or more members of the data center hierarchy, wherein the organization hierarchy including a plurality of data center consumer entities arranged in a parent-child form and the data center hierarchy including one or more hosts, each including the plurality of computing resources, wherein each of the plurality of computing resources includes at least one of a CPU, a disk, a Network Interface Card (NIC), and a memory;
retrieving usage data of each of the plurality of computing resources, the usage data being retrieved for a selected period of use of each of the plurality of computing resources by either the data center consumer entity or a parent entity of the data center consumer entity;
retrieving a rate plan data for the data center consumer entity;
retrieving per unit charge, base rate, and rate factor for each of the plurality of computing resources; and
calculating a sum of multiplications of billed units of each of the plurality of computing resources by per unit charge, base rate, and rate factor, the billed units include one of actual used units or reserved units, wherein the rate plan data includes information whether the actual used units or the reserved units to be used in calculating the sum,
wherein, the use charges for a child consuming entity being aggregated to the parent entity of the child consuming entity in the organization hierarchy.

2. The method as recited in claim 1, wherein the rate plan data includes at least one of a fixed rate plan, an actual use based plan, a reservation based plan.

3. The method as recited in claim 1, wherein the usage data includes a data center hierarchy, the data center hierarchy including a plurality of hosts and a plurality of virtual machines grouped to form one or more computing resource pools.

4. The method as recited in claim 1, wherein the rate plan data further includes an organization hierarchy, the organization hierarchy including a plurality of data center consumer entities grouped in a parent-child form based on an organization structure.

5. The method as recited in claim 4, wherein the rate plan data further includes a mapping of members the data center hierarchy with the plurality of data center consumer entities in the organization hierarchy.

6. The method as recited in claim 5, wherein calculating the sum includes apportioning use charges of a particular data center computing resource among child entities of a data center consumer entity in the organization hierarchy if the particular data center computing resource is mapped to the data center consumer entity and the entity having the child entities.

7. The method as recited in claim 4, wherein a data center computing resource in the plurality of data center computing resources configured to be accessed by two or more of the plurality of data center consumer entities.

8. The method as recited in claim 7, wherein the calculating further includes apportioning use charges of the data center computing resource among the two or more of the plurality of data center consumer entities.

9. The method as recited in claim 1, further includes updating at least one of the per unit charge, the base rate, and the rate factor for a computing resource that is associated with a virtual machine being used by the data center consuming entity when the virtual machine is moved from one host to another host.

10. The method as recited in claim 1, wherein the plurality of data center resources include a subset of all data center computing resources in the data center hierarchy.

11. An apparatus for calculating computing resource use charges for a data center consumer entity, the data center consumer entity accessing a plurality of computing resources in a data center, the apparatus comprising:
a usage data collector module to collect usage data of each of the data center computing resources;
a cost calculation module in communication with the usage data collector for calculating the computing resource usage charges based on usage and a rate plan;
a chargeback database to store the rate plan; and
a reporting module to generate a use charges report for a selected usage period and a selected one of the plurality of data center consumer entities based on cost calculations by the cost calculation module.

12. The apparatus as recited in claim 11, further comprising a user interface to enable input of the selected usage period and the selected one of the plurality of data center consumer entities.

13. The apparatus as recited in claim 11, further comprising a monitoring database in communication with the usage data collector module to store the usage data of each of the data center computing resources.

14. A computer readable media to store programming instructions for calculating computing resource use charges for a data center consumer entity, the data center consumer entity accessing one or more of a plurality of computing resources in a data center hierarchy, the data center consumer entity being a member of an organization hierarchy, the computer readable media comprising:
programming instructions for creating mappings between one or more members of the organization hierarchy and one or more members of the data center hierarchy, wherein the organization hierarchy including a plurality of data center consumer entities arranged in a parent-child form and the data center hierarchy including the plurality of computing resources, wherein each of the plurality of computing resources includes at least one of a CPU, a disk, a Network Interface Card (NIC), and a memory;
programming instructions for retrieving usage data of each of the plurality of computing resources, the usage data being retrieved for a selected period of use of each of the plurality of computing resources by either the data center consumer entity or a parent entity of the data center consumer entity;
programming instructions for retrieving a rate plan data for the data center consumer entity;
programming instructions for retrieving per unit charge, base rate, and rate factor for each of the plurality of computing resources; and
programming instructions for calculating a sum of multiplications of billed units of each of the plurality of computing resources by per unit charge, base rate, and rate factor, the billed units include one of actual used units or reserved units, wherein the rate plan data includes information whether the actual used units or the reserved units to be used in calculating the sum,
wherein, the use charges for a child consuming entity being aggregated to the parent entity of the child consuming entity in the organization hierarchy.

15. The computer readable media as recited in claim 14, wherein at least one of the per unit charge, the base rate, and the rate factor being configured to vary from one time period to another time period.

16. The computer readable media as recited in claim 14, wherein at least one of the per unit charge, the base rate, and the rate factor being configured to different values for different time slots.

17. The computer readable media as recited in claim 14, further includes programming instructions for updating at least one of the per unit charge, the base rate, and the rate factor for a virtual machine in the plurality of computing resources when the virtual machines is moved from one host to another host in the plurality of computing resources.

18. The method as recited in claim 14, wherein the plurality of data center resources include a subset of all data center computing resources in the data center hierarchy.

19. The computer readable media as recited in claim 14, wherein the usage data includes a data center computing resource hierarchy, the data center computing resource hierarchy including a plurality of hosts and a plurality of virtual machines grouped to form one or more computing resource pools.
